(19) United States
(12) Patent Application Publication
(10) Pub. No.: US 2019/0110643 A1
(43) Pub. Date: Apr. 18, 2019

(54) SMART CHARGER PLATE

(71) Applicants: Gloria Contreras, Austin, TX (US); Shankar Ghimire, Fairfax, VA (US)

(72) Inventors: Gloria Contreras, Austin, TX (US); Shankar Ghimire, Fairfax, VA (US)

(21) Appl. No.: 15/784,083

(22) Filed: Oct. 14, 2017

(51) Int. Cl. A47J 39/02

(52) U.S. Cl. CPC A47J 39/02

(57) ABSTRACT

A smart charger plate heater for heating dinner plates. The charger plate heater is configured to detect the use of the charger plate by sensing the temperature and weight, and automatically set a heating temperature to heat the charger plate after a time-period. Heating of one or more such charger plate may started/controlled by a mobile device using a single touch. The charger plate in use and not in use status is displayed in a layout format for easy view, heating control and identification of location of table/seat where a service is needed.

### FIELD

Example embodiments of the inventive concepts relate to a charger plate heating system and method.

### BACKGROUND

Existing charger plates are purely decorative and serve to “dress-up” a dinner table in more formal dining settings.

Available methods for heating dinner plates are inconvenient No solutions are provided for managing food serving and charger plate heating in an environment where there are a large number of users.

### SUMMARY

In-an example embodiment the inventive, aspect transforms a decorative charger plate into a functional, high-end device configured to heat the dinner plate for fine dining and entertaining.

In an example embodiment, a flat and portable platform for healing a dinner plate, the platform comprises at least a temperature sensor configured to sense a temperature of the food received in the dinner plate; a plurality of weight sensors installed at the bottom of the platform, the plurality of the weight sensors being configured to sense the weight of the food received in the dinner plate; a power storage element inside the platform; a heating element configured to heat the dinner plate placed on the platform; a control circuit configured to receive an electrical signal from the at least one temperature sensor and a plurality of weight sensors to control the operation of the heating element based on the received signal from the temperature sensor and the plurality of weight sensors; and a wireless transceiver communicating with a remote mobile device or a computer, the wireless transceiver being configured to transmit the sensed temperature and weight signal to the mobile device to display the sensed temperature of the platform.

In an example embodiment, the controller is configured to control the temperature of the platform based on the temperature signal received from the temperature sensor and weight signal received from the weight sensors.

In an example embodiment, the platform includes a display to display the target, heating temperature and duration of the heating of the platform.

In an example embodiment, a manual switch is provided on the platform, the manual switch being configured to manually override a set temperature and duration of the heating of the platform.

In another example embodiment, a charger plate comprises a bottom heating element connected to a battery mounted on a slope or elevated portion of the charger plate; and a switch to turn on or off a power supply of the battery to the bottom heating element.

### BRIEF DESCRIPTION OF THE DRAWINGS

The example embodiments of the inventive concept will be better understood from t he following brief description taken in conjunction with the accompanying drawings. The drawing FIGS. 1-15 represent non-limiting, example embodiments.

FIG. 1 shows a plurality of flat and portable platforms for heating dinner plates, according to an example embodiment.

FIG. 2 shows a layout of in use and not in use platforms in a smart device like I-phone, according to an example embodiment.

FIGS. 3A-3B show a top view of a flat and portable platform for heating a dinner plate, according to an example embodiment.

FIGS. 4A-4B show a top view of a round and portable platform for heating dinner plates with user control buttons, according to an example embodiment.

FIGS. 5A-5B illustrates a portable platform for heating dinner plates with decorative bands, according to an example embodiment.

FIG. 5C shows a charger plate or dinner plate placed over the flat and portable heating platform, according to an example embodiment.

FIG. 6 shows various electrical components, sensors, and interconnections circuitry involved in controlling heating in a charger plate heater or in a portable platform, according to an example embodiment.

FIG. 7 shows a charger plate having embedded circuitry, replaceable battery and heating element inside the charger plate, according to an example embodiment.

FIG. 8A shows a charger plate with bottom empty portion for accommodating the housing 600′, according to an example embodiment.

FIG. 8B shows a side view of the charger plate with a bottom empty portion (slot) for accommodating the housing 600′, according to an example embodiment.

FIG. 8C shows a side view of a housing 802 comprising circuitry, replaceable and rechargeable battery, and heating element, according to an example embodiment.

FIG. 9 shows a bottom view of sensors, rechargeable battery and circuitry arrangement, according to an example embodiment.

FIG. 10 shows a communication channel and interface arrangement for memory and processor, according to an example embodiment.

FIG. 11A shows a charger plate with the middle portion comprising a metal top as a heat conducting element. The middle portion is shown separate from the remaining portion of the charger plate.

FIG. 11B shows a charger plate of FIG. 11A where the middle portion is shown flush with the remaining portion of the charger plate, according to an example embodiment.

FIG. 12 shows a bottom view of FIG. 11A or FIG. 11 B, according to an example embodiment.

FIG. 13 shows a charger plate where curved and rechargeable batteries ate attached on the sloped side wall of the charger plate, according to an example embodiment.

FIG. 14 shows another embodiment of FIG. 13 wherein several rechargeable batteries 141 are

attached on the sloped or elevated side wall, according to an example embodiment.

FIG. 15 shows a charger plate having a rechargeable, thin and curved battery on the sloped or elevated sidewall (outside) of the charger plate, according to an example embodiment.

FIG. 16 shows a charger plate with a band of battery in the sloped, or elevated sidewall of the charger plate, according to an example embodiment.

FIG. 17 shows an interconnection inside the charger plate, according to an example embodiment.

### DETAILED DESCRIPTION

In the following description, reference is made to the accompanying drawings which form a part hereof, and in which is shown by way of illustration specific embodiments in which the inventive concept may be practiced. These embodiments are described in sufficient detail to enable those skilled in the art to practice the inventive concept, and it is to be understood that the embodiments may be combined, or that other embodiments may be utilized and that structural and logical changes may be made without departing from the spirit and scope of the present inventive concept. The following description is, therefore, not to he taken in a limiting sense.

Example embodiments, of the inventive concepts may be embodied in many different forms and should not be construed as being limited to the embodiments set forth herein; rather, these embodiments are provided so that, this disclosure will be thorough and complete, and will fully convey the concept of example embodiments to those of ordinary skill in the art. In the drawings, some dimensions are exaggerated for clarity.

It will be understood that when an element is referred to as being “connected” or “coupled” to another element, it can be directly connected or coupled to the other element or intervening elements may be present.

The terminology used herein is for the purpose of describing particular embodiments only and is not intended to be limiting of example embodiments of the inventive concepts. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with, their meaning in the context of the relevant art and will not he interpreted in an idealized or overly formal sense unless expressly so defined herein.

Charger plates are large, decorative plates, and come in a wide variety of materials and colors. This inventive aspect adds a functional heating component to the charger plates that keeps food warm on a dinner plate once the dinner plate is placed onto the charger plate.

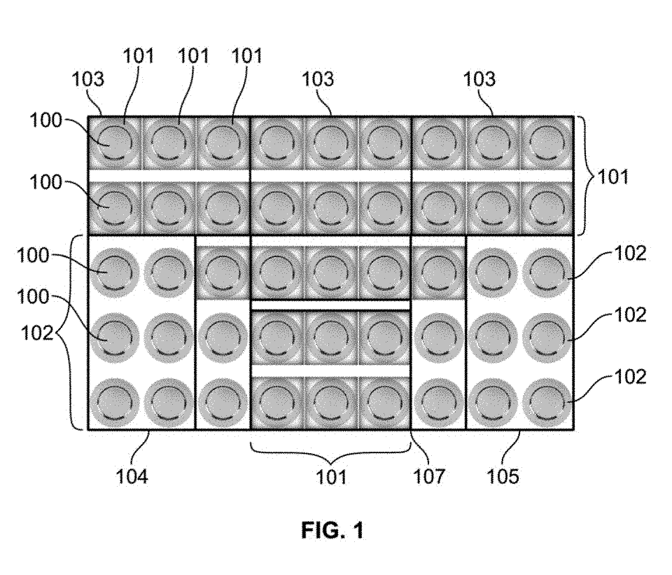

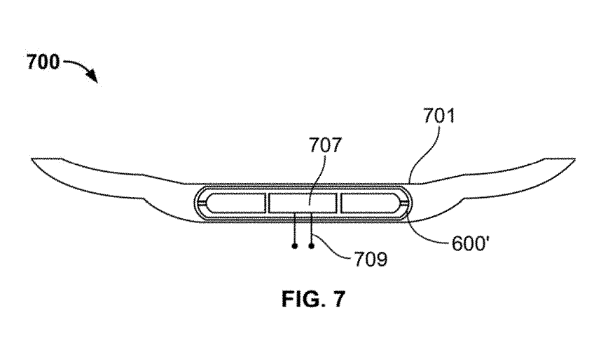

Example embodiments describe system and method for heating dinnertime decor accessory (i.e. a charger plate) that are placed under a dinner plate to keep the food warm on the dinner plate. In this disclosure, some example embodiments describe a fiat and portable platform (shown in FIGS. 1-5B) that are configured to heat the charger plates. Other example embodiments describe the charger plates (shown in FIGS. 7-8C and 11A-16) that comprise heating mechanism and are configured to heat the dinner plates that are placed onto the charger plate. In this disclosure, the charger plate or flat portable platform may have been interchangeably used to describe their functions, elements/components or operations.

FIG. 1 shows a plurality of flat and portable platforms 100 for heating dinner plates. Platforms 101 are currently in use. Platforms 102 are currently not in use. In this disclosure, in use, indicates that the user has used or intended to use the platform to heat his dinner plate. As shown in FIG. 1, some dinner tables are occupied and some dinner tables are unoccupied. For example, dinner table 103 is fully occupied and the platforms 101 are in use. In the dinner table 104, the platforms 102 are not in use. In the dinner table 107, the platforms 101 are in use.

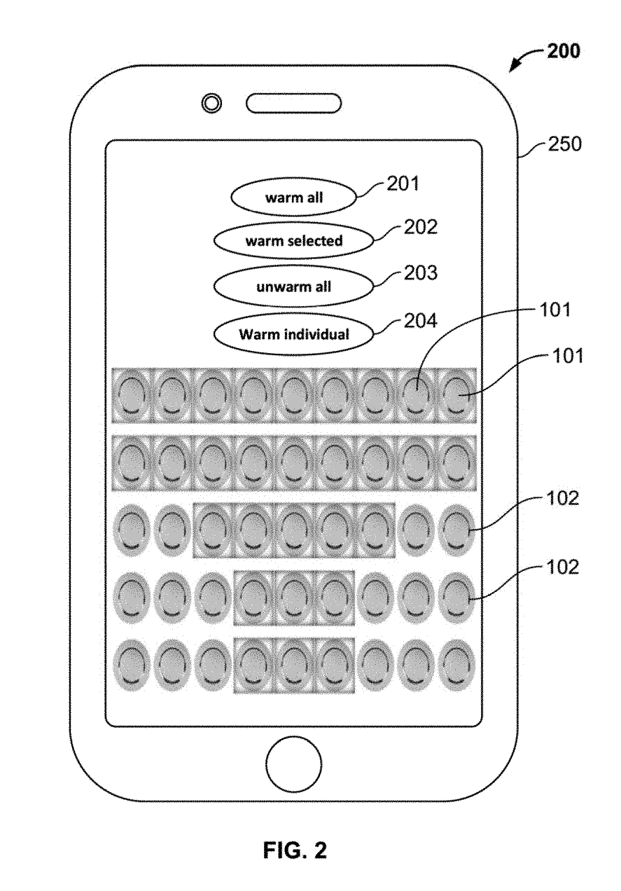

FIG. 2 shows a layout 200 of the used platforms 101 and unused platforms 102 in a smart device like I-phone. In other words, layout 200 illustrates mapping of position, and use or unused status of the heating platforms in a layout form for the user to quickly gauge the status of platforms to start heating of the dinner plates as needed, in an example embodiment, selectable touch buttons 201, 202, 203 and 204 may be used to start or control heating of the platforms 100. To warm all the platforms 100 in the layout, a user can use warm all touch button 201. Alternatively, a user can select the platforms to be warmed and use the warm selected touch button 202 to warm the selected platforms in the layout. To unwarm all the platforms in the layout a user can use unwarm all touch button 2021 En an example embodiment, a user can first select warm individual button 204 and touch the individual touch button in the layout to warm each individual platform 100 selectibly.

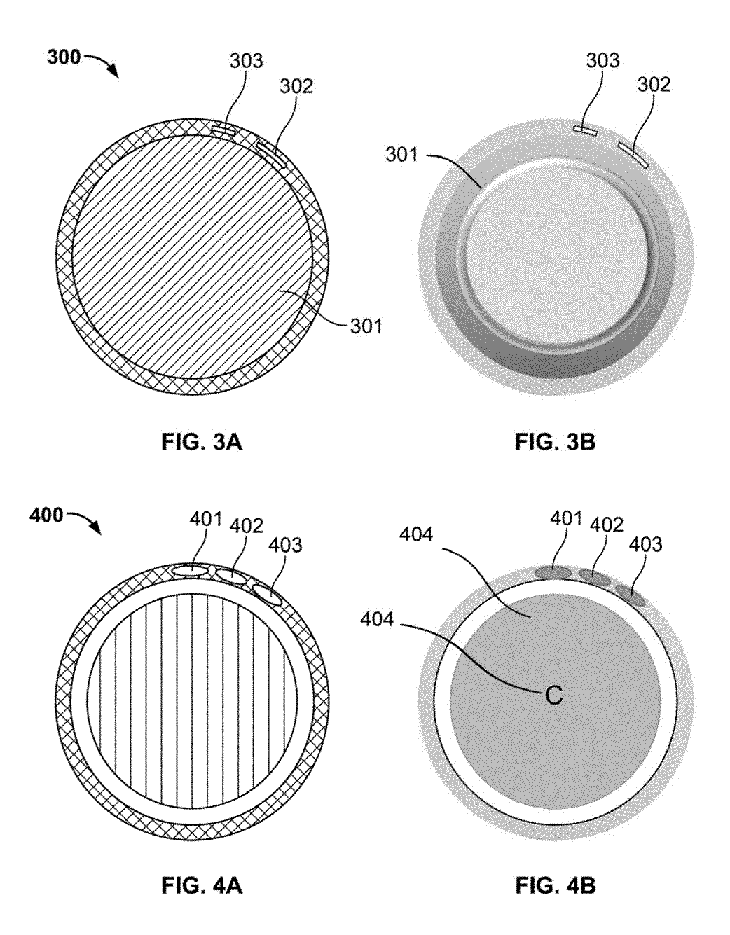

FIGS. 3A-3B show a top views of such a portable platform 100 for heating dinner plate described in FIG. 1, according to an example embodiment. Platform 300 may round or circular or oval shaped flat platform. In another example embodiment, such, platform may have a shape suitable to receive the dinner plates to be heated as the food is served. Such platforms may also include decorative ornamental designs on the surface. In FIG. 3A, the heating element resides under portion 301. 301 may be a heat conducting polymer with high melting point. In an example embodiment, 301 may be a metal or a combination of a metal and porcelain or a combination of metals.

In an example embodiment, the platforms 300 includes a display 302 to display the target heating temperature and duration of the heating of the platform. A manual touch switch 303 is provided on the platform 300. The manual switch is configured to manually override a set temperature and duration of the heating of the platform. The position of display 302 and switch 303 may be switched for ease of use.

FIGS. 4A-4B show a top view of a round platform 400 with user control buttons 401, 402 and 403. The user control button 401 may be used to display heating status (currently heating or not), the user control button 402 may be used to override all remote control commands and start controlling of heating locally. The user control button 403 may be used to set heating temperature locally. In an example embodiment, such locally heating temperature may be set at 75 F, 80 F, 85 F, 90 F, 95 F, 100 F, 105 F and 110 F. As the user presses the button 403, new set temperature would show up in the button and set the beating at that temperature. Set the heating at a temperature indicate that a measurement of heating around the heater is about the above temperatures. The temperature of the food being heated may be same or different based on the surrounding and the amount and existing hotness of the food sewed.

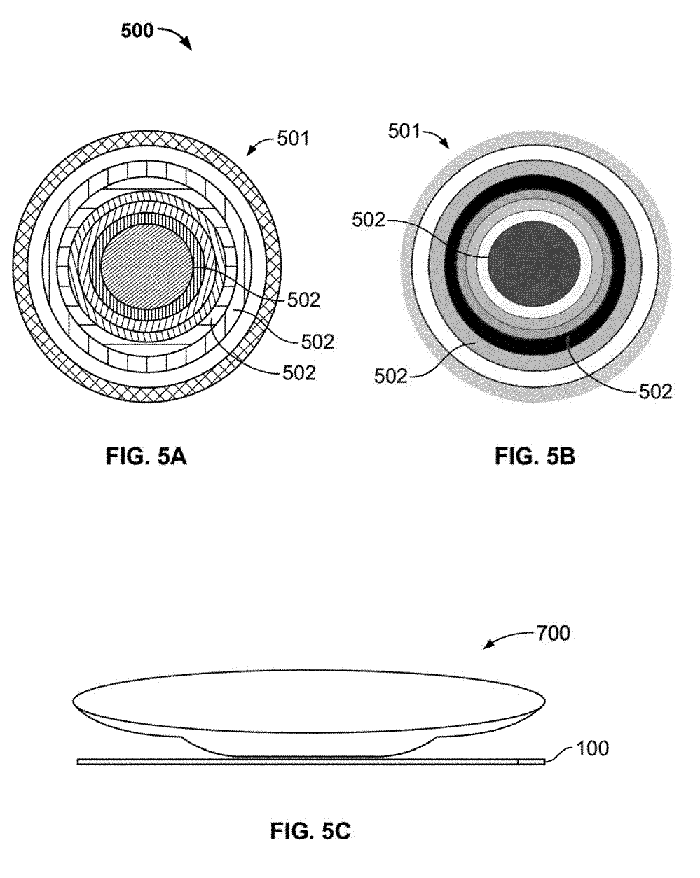

FIGS. 5A-5B illustrates such a portable platform 500 according to another example embodiment. Various circular bands 502 may be heating or heat conducting elements. In another example embodiment, above these bands decorative bands may be printed. Decorative bands may be added based on use. For example, various pictures representing peace, love, humbleness, respect, friendship, emotions, culture, location, art etc. may be printed on the platform. In an example embodiment, the decorative features may be added later as demanded by a user. For example, letters, characters may be printed at the center of the platform. For example, in FIG. 4B, a letter C is printed at the center 404 of the platform.

FIG. 5C shows a charger plate or a dinner plate 700 placed over the flat and portable heating platform 100 according to an example embodiment. Such flat and portable heating platform are for example platform 100, platform 300, platform 400 and platform 500.

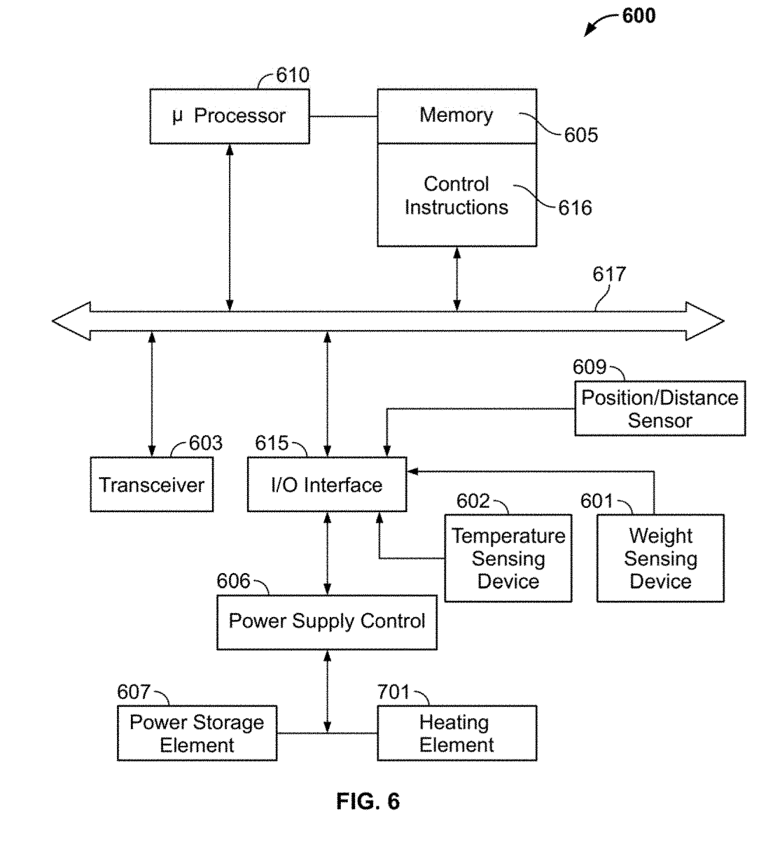

FIG. 6 shows various electrical components, sensors, and inter connections circuitry 600 involved in the heating flat and portable platform (platform 100, platform 300, platform 400 and platform 500) or the heating charger plate 701. In an example embodiment, the flat and portable platform for heating a dinner or charger plate 700 plate comprises at least a temperature sensor 602 configured, to sense a temperature of the food received in the dinner plate 700 or the temperature of the dinner or charger plate itself; a plurality of weight sensors 601 installed at the bottom of the platform at various position, the plurality of the weight sensors being configured to sense the weight of the food received in the dinner plate 700; a power storage element (a rechargeable battery) 607 inside the platform; a heating element 701 configured to heat the dinner plate 700 placed on the platform; a power supply control 606 configured to receive the control signal front the micro-processor, the control signal being based on the received electrical signal from the at least one temperature sensor 602 and a plurality of weight sensors 601, to control the operation of the heating element 701 based on the received signal from the temperature sensor 602 and the plurality of weight sensors 601; and a wireless transceiver 603 communicating, with a remote mobile device 250 or a portable computer 250, the wireless transceiver being configured to transmit the sensed temperature and weight signal to the mobile device to display the sensed temperature of the platform. The received, temperature and weight signals are processed by the mobile device's microprocessor and a control command(s) is transmitted to the platform. This control command is received by the transceiver 603 and send to the memory 605 for storing and generating instructions based on the sensed data to control the power supply control. The processor receives these instructions and executes to control the power supply according the sensed data.

The power supply control 606 is configured to control the temperature of the platform 300 based on the temperature signal received from the temperature sensor 602 and weight signal received from the weight sensors 601. In example embodiment, the controller is configured to control the temperature of the platform by controlling the electrical power supplied to the heating element. In another example embodiment, the transceiver 603 is a wireless controller is configured receive the temperature control instructions, from the mobile device 250. The instructions are then sent to the controller to control the operation of the heating element based on the signal received from the mobile device 250.

In an example embodiment, a received signal from a temperature sensor 602 or a weight sensor 601 is amplified by an amplifier and is sent to a A/D converter. The converted signal is then passed through the I/O interface to the data bus 617 and stored in the memory 605. The memory includes control instructions 616 for controlling the power supply control 606 for controlling the power supply of the power storage element 607 to the heating element 701. The control instructions 617 may be installed in the memory via an I/O port. The power supply control 606 may be simple switch the is configured to connect or disconnect the heating element 701 (such as heater coil) to a source of electric power 607 upon receiving commands from the microprocessor 610. In an example embodiment, the power supply control may be a network of resistance that is configured to change the resistance in accordance with the command supplied by the microprocessor 610 to regulate the current supplied to the heating element 701. In another example embodiment, the power supply control may be a combination of a digital, switch and a network of resistance that is configured to change the resistance in accordance with the command supplied by the microprocessor 610 to regulate the current supplied to the heating element 701. In yet another example embodiment, the power supply control may be a digital potentiometer configured to change the resistance in accordance with the command supplied by the microprocessor 610 to regulate the current supplied to the heating element 701. In yet another example embodiment, the power supply control may be a digital potentiometer and a digital on off switch, configured to change the resistance in accordance with the command supplied by the microprocessor 610 to regulate the current supplied to the heating element 701.

In an example embodiment, the microprocessor functions based on the program logic stored in the memory 605. In other embodiment, the microprocessor 610 may have its own memory to instruct the functions of the processor.

In an example embodiment interface 615 is configured to receive or send signals to the temperature sensing device 602, weight sensing device 601 or power supply control 606. The interface includes an A/D converter to convert the analog signals received from the sensors to the digital signals. The I/O interface may also include additional circuitry to control signals received from the processor via data bus to change into the compatible/usable format to and for the devices 602, 601, 606 and 603.

In another example embodiment, the mobile device 250 receives sensed data from the position sensing device 609. The sensed data from die position sensing device 609 includes the position data with respect to its neighboring platforms along with the identification information of the neighboring platforms and its position data with respect to the mobile device itself. The mobile device's microprocessor uses the sensed data to determine the location information of the platforms by using triangulation method. The determined position data along with the identification information is used to generate a layout of the platforms that maps the relative position information of the platforms.

In an example embodiment, the position sensing device 609 may be a Bluetooth indoor positioning device such as Bluetooth low energy or Bluetooth smart having accuracy of detection from about 1 m to about 30 m. When the position sensing device is Bluetooth position sensing device, the position information is sent to the smart phone or the computer by Bluetooth antenna of the Bluetooth position sensing device.

In an example embodiment, the mobile device uses the received data from the weight sensor and temperature sensor along with the identification and position information of each platform to determine currently used and unused platforms and generate the layout as shown in FIG. 2.

In another example embodiment, the weight sensor data may be used to display on the smart phone to differential weight on the dinner plate and its location on the layout of the platform and determine whether further food service is needed to a user in a location.

In an example embodiment, the transceiver sends the received temperature data from the temperature sensor 602 to a mobile device 250. The mobile device compares the received data from the transceiver with a reference data in its memory and send instruction to the processor 610 via transceiver 603. The processor then executes the instruction and sends control signal to the power supply control 606 to instruct the power control to send (or stop sending) current to the heating element 701.

In another example embodiment, the weight sensing device 601 sends the weight signal to the transceiver. The transceiver sends the weight signal to the remote device 250. Based on the weight data, the remote phone or computer sends the control instructions to the transceiver in order to control the power supply. The received control signal is processed and executed by the micro-processor and is sent to the power supply control 606.

In an example embodiment, the transceiver 603 may have its own I/O interface coupled to the bus 617. Transceiver may also have its own amplifier an A/D converter. The transceiver 603 receives the wireless signal from the mobile device to control the operation of the power supply control 606.

FIG. 7 shows a charger plate, according to an example embodiment. In an example embodiment, the charger plate includes an embedded circuitry 600, replaceable battery 707 and heating element 701 inside the charger plate 700. The battery 707 is replaceable and is configured to insert inside the housing 600′ and connects with the circuitry to provide the power supply and is connected to the heating element via the power control 606. The battery 707 may be charged using the connection 709.

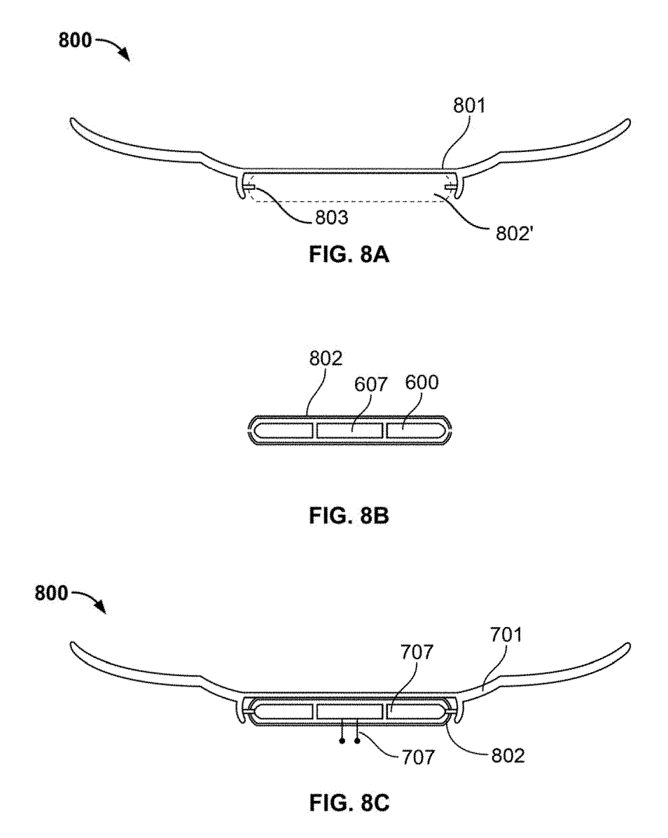

FIG. 8A shows a side view of the charger plate 800 comprising an externally attachable circuitry and power supply embedded inside a housing 802. In an example embodiment, an extended pin arrangement 802 is used to align the insertion of the housing 802 at the bottom of the charger plate 802′, according to another example embodiment. The circuitry 600, replaceable battery 707 and heating elements are housed in a single housing 802. In another example embodiment, the housing 802 can be inserted into the slot 802′ using a guide and groove arrangement and removably attached with the charger plate 800.

FIG. 8B shows cross-section view of housing 802.

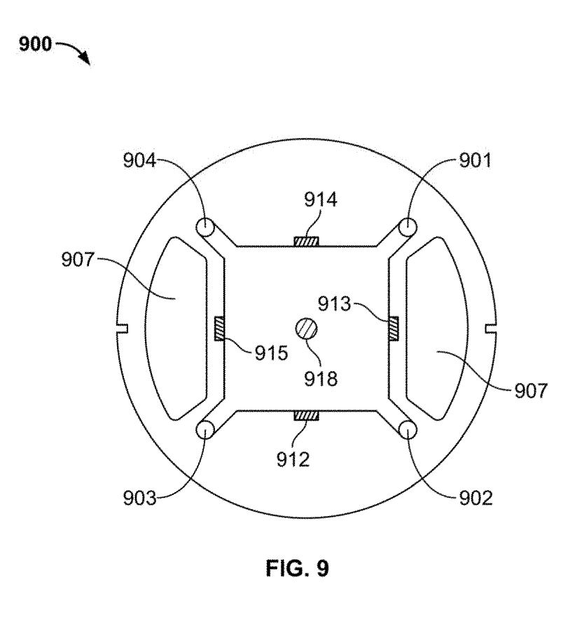

FIG. 8C shows bottom view of the sensor and battery and circuitry arrangement 800. In an example embodiment, the weight sensors 901, 902, 903 and 904 are arranged at the corners. Temperature sensors 914, 915, 912 and 913 are arranges as shown in FIG. 9. Batteries 907 are arranged on the side. A groove arrangement is provided on the two side of the housing to allow for the housing 802 to slide through into the bottom, of the charger plate and removably attached.

In another example embodiment, a system for heating a plurality of dinner plates includes a plurality of flat and portable platforms 101-150 for heating the plurality of dinner plates, each of the plurality of platforms including, at least a temperature sensor 602 configured to sense a temperature of the food received in the dinner plates; a plurality of weight sensors 601 configured to sense the weight of the food received in the dinner plates; a heating element 701 configured to heat the dinner plate received on the platform; a power storage element 607 inside the platform to energize the heating element 701; a control circuit 606 configured to receive an electric signal from the at least one temperature sensor 602 and a plurality of weight sensors 601, to control the operation of the heating element 701 based on the received temperature signal from the temperature sensor 602 and the received signal from the plurality of weight sensors 601; a wireless transceiver 603 operatively communicating with a remote mobile device 250 or a computer, the wireless transceiver being configured to transmit the sensed temperature arid weight signal to the mobile device to display the sensed temperature of the platform; wherein, each of the plurality of the platforms are configured to receive a command from the remote mobile device or the computer to control the operation of the heating element 701 of each of the plurality of the platforms at a target temperature. In an example embodiment, the target temperature is between 75 degree F. to 100 degree F. In another example embodiment, the target temperature is between 85 degree F. to 100 degree F. In another example embodiment, the target temperature is between 85 degree F. to 120 degree F. In another example embodiment, the target temperature is adjustable to heat the dinner plate.

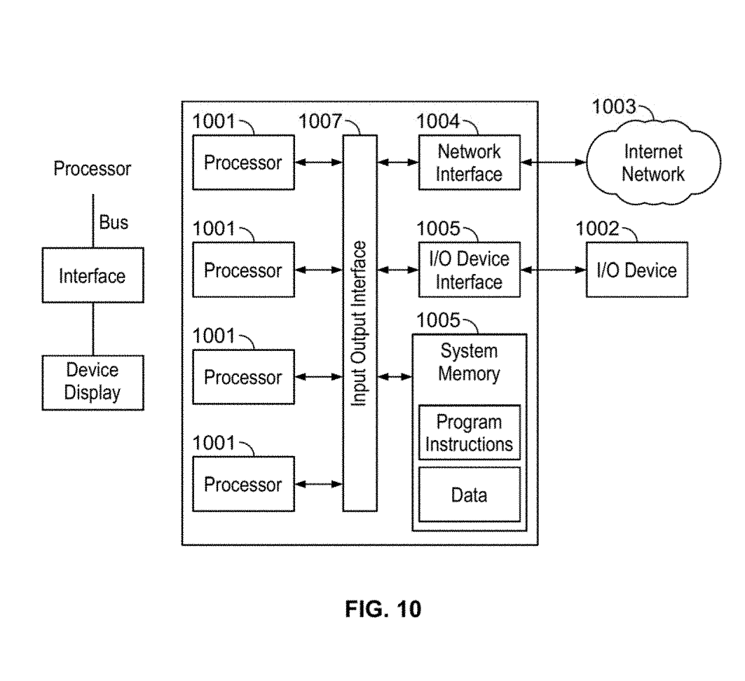

FIG. 10 shows an example communication channel for memory and processor. An input and output interface 1007 is provided to communicate with the processor 1001. Network interface 1004, I/O drive 1005, memory 1006 with instruction stored therein for the execution the by the processor, communicates with the processor via I/O interface 1007. Network interface 1004 allows the processor to communicate with the external network 1003. Further device input/output interface may be added according to the need.

In example embodiment, a group of the platforms 101-150 are configured to receive a control, command from the mobile device 250 by a single input (201, 202, 203, 204) in the mobile device to control the temperature of the group of the platforms.

The single input in the mobile device is a touch input, in the touch screen of the mobile device.

In another example embodiment, the mobile device 250 is provided with an application such that in response to sending the sensed temperature or weight information from the temperature sensor 602 or weight sensors 601, the mobile device displays a layout 205 of the used platforms by a plurality of users.

In an example embodiment, the layout 200 includes platform positions that are selectable by a user of the mobile device to control the temperature of each of the platforms via a single input (201, 202, 203, 204) or via individual inputs (210-245) corresponding to each of the platforms.

In example embodiment, the layout includes enabled buttons (201, 202, 203, 204) that are configured to control the temperature of the plurality of the platforms.

In another example embodiment, the app provides a preselectable temperate ranges to control the temperature of the plurality of the platforms.

The above flat and portable platforms for heating charger plates may be used separately as described above. However, the components and features used in the flat and portable platforms may be used along with the charger plates or vice versa. In other words, the electrical circuitry and components, heating elements, rechargeable battery and housing described above to house the above-mentioned components may be interchangeably used in flat and portable platform or in the charger plate.

In an example embodiment, the charger plate is made from porcelain. In another example embodiment, the charger plate is made from porcelain and metal with metal being at top of the bottom side of the charger plate.

In an example embodiment, the charger plate is made from a material having a thermal conductance between 1 to 386 W/m K. For example, a porcelain may have thermal conductance of about 5 W/m K and the steel used at the top of the bottom side as heat conducting material may have the conductivity of about 50 W/m K.

In another example embodiment, the charger plate is made from combination two different materials having different thermal conductance, the material being selected such the thermal conductance would have a corresponding value from a range, between 1 W/m K to 386 W/m K based on the material chosen. For example, the top of the bottom portion of the charger plate may be made from steel (50 W/m K) and the remaining portion of the charger plate may be made from porcelain 15 W/m K). The combination of materials may be chosen such that comfortable hating is generated by the charger plate heater platform.

In an example embodiment, the bottom portion of t he charger plate may be made in combination of the two or more material selected from the fable below.

| Metal | Metal |
|---|---|
| Admiralty Brass | Cupronickel |
| Aluminum, pure | Gold |
| Aluminum Bronze | Beryllium Copper |
| Carbon Steel, | Iron, nodular |
| max 0.5% C | pearlitic |
| Carbon Steel, | Iron, pure |
| max 1.5% C | |
| brass | Iron, wrought |
| Copper, pure | Platinum |
| Stainless Steel | Red Brass |
| Copper bronze | Silicone |
| (75% Cu, | |
| 25% Sn) | |
| steel | platinum |
| Copper brass | Silver, pure |

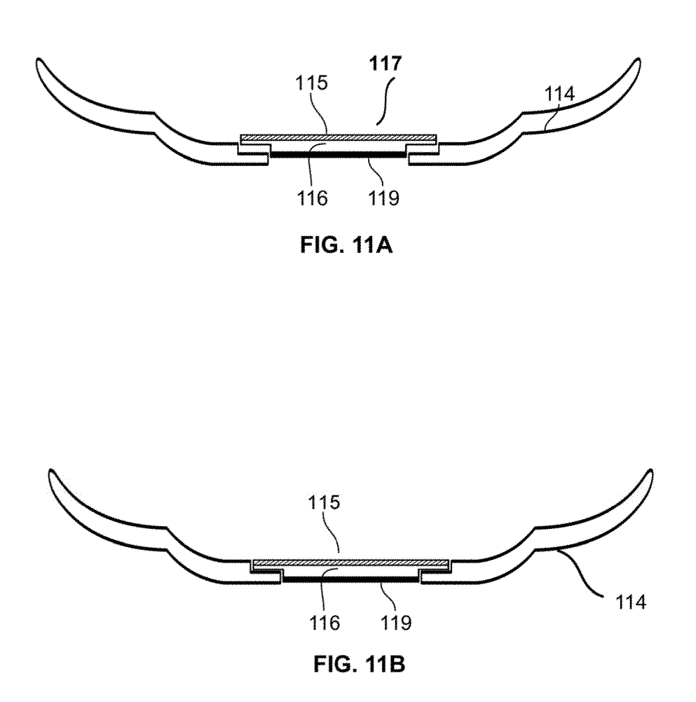

FIG. 11A shows a charger plate with middle portion 117 made from a metal top, as heating and heat conducting element 115. Top most layer is the heat conducting metal 115 and just under the top 115 is a heating element 701. The circuitry and rechargeable power supply are housed inside a housing 119 which also comprises heating 701 and heat conducting element 115. The housing package 119 can be attached to the porcelain 114 by bringing the housing 119 from the top and fitting with an opening in the bottom portion of the porcelain. The metal top has an extended rim so that it is retained by the porcelain 114 and flushes (with continuous plane) with the surface of the porcelain.

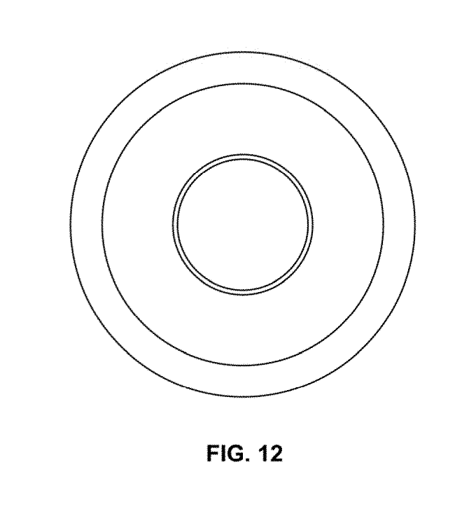

FIG. 11B shows the middle portion 117 fitted with the remaining portion of the charger plate. FIG. 12 shows a bottom view of FIG. 11B.

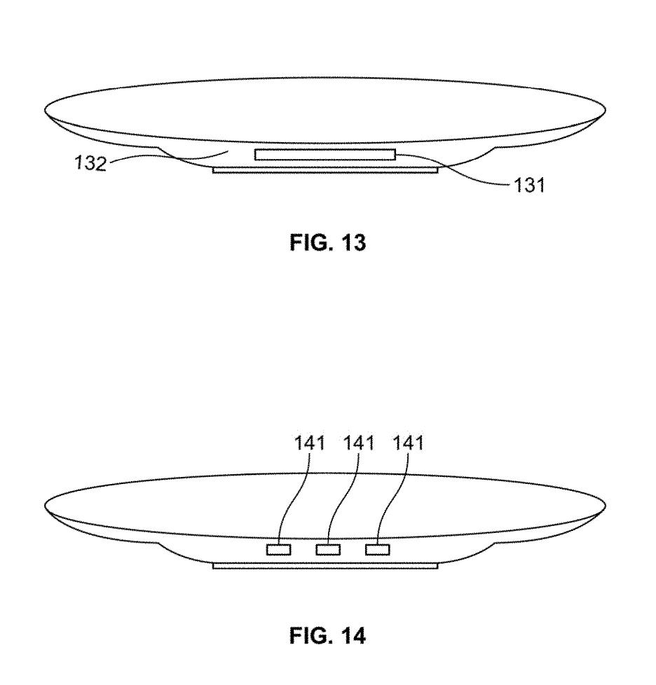

FIG. 13 shows another embodiment of FIG. 11 wherein rechargeable battery 131 (with the curved and bent surface), are attached on the side so that they can be attached evenly on the side wall 132 of the porcelain.

FIG. 14 shows another embodiment of FIG. 11 wherein several rechargeable batteries 141 are attached on the side wall (in the outer sidewall 132) in parallel and are conformal to the surface of the side wail of the porcelain so that they can be attached evenly on the wall of the porcelain. The configuration of FIG. 13 and 14 allows to form reduced height of the charger plate as illustrated in FIGS. 11-14

In an example embodiment, the thermal conductivity of the porcelain material is 5 watts per meter-kelvin (W/m K). However, higher thermal conductivity porcelain may be used for faster heat transfer. In another example embodiment, the thermal conductivity of the materials used in the charger plate may be selected between 1 to 300 W/m K.

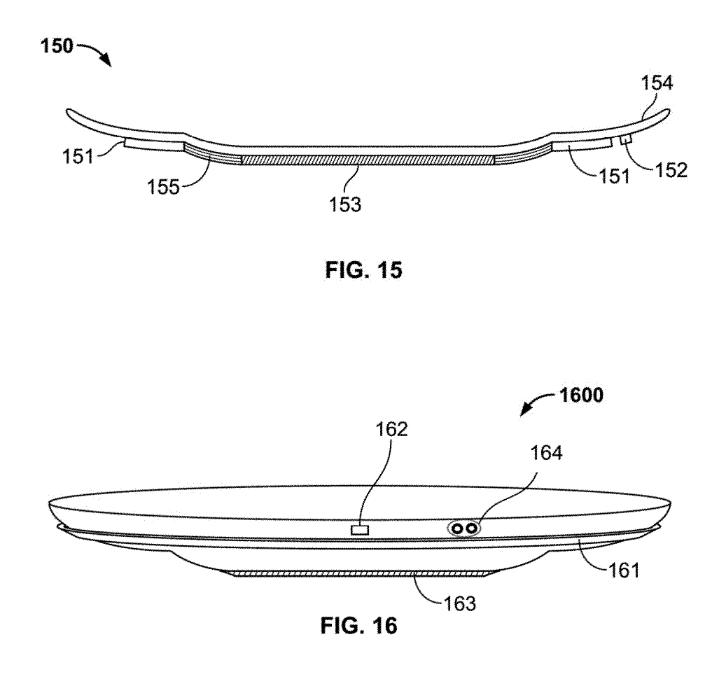

FIG. 15 shows a charger plate 150 having a rechargeable thin and curved battery 151 on the outer sidewall 132 of the charger plate. At the bottom of the charger plate is a polymer heater 163. The polymer heater may be screen printed on the bottom of the charger plate or prepared separately and attached to the bottom.

In an example embodiment, such polymer heater 163 is a polymer thick film (PTF) heater material along with printed conductive inks.

In an example embodiment, the polymer heater 163 maybe the material having heating elements with self-regulating properties so that the same material may function as a heater as well as the sensor to regulate the heating of the charger plate.

In another example embodiment, the PTF 163 is manufactured by using screen printing method and may be designed using conductive inks and substrates. In an example embodiment, such polymer heater 163 may be standard Resistance PTF heater.

In another example embodiment, the polymeric may be manufacture by screen printing a metal-based paste onto a polyester sheet with a substantially radially symmetrical circuit pattern. Next, sheet is cured by drying the circuits are then configured by appropriate termination according to the required size, hi an example embodiment, for appropriate bonding, an adhesive may be applied to the circuit pattern.

In yet another example embodiment, a method for making a charger plate for heating a dinner plate is provided. The method comprises steps of,
a. attaching a polymeric thick film heating element on the bottom of the charger plate, the polymeric thick film heating element comprising screen printed circuit patterns and being configured to heat the charger plate;
b. attaching one or more thin, curved or bent rechargeable batteries on the outer side wall of the charger plate, the rechargeable battery including a switch configured to connect or disconnect the battery with the polymeric thick film heating element; and
c. operatively connecting the polymeric thick film heating element with the terminal of the rechargeable batteries such that the polymeric heating element is energized by the battery power to generate heat to heat the charger plate and the dinner plate received on the charger plate.

FIG. 16 shows a charger plate 1600 composing a thick film polymeric heating element 163 at the bottom, a thin band of battery (battery band) 161 attached to the outer side wall 132 along the circumference, a switch 162 and a plugin for recharging the battery band by the external power source.

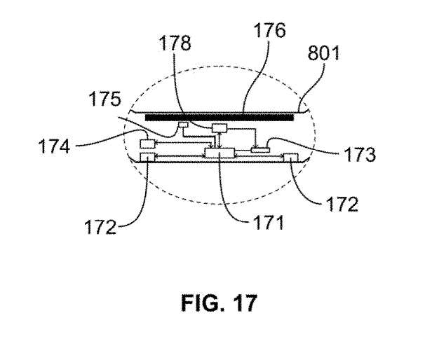

FIG. 17 shows various electrical circuitry/components and battery inside the housing. In an example embodiment, heating element 176 is connected to the rechargeable battery 173 via power supply control 178. Controller 171 comprises microprocessor 610, memory 605 with stored control instructions 616, bus 617, and I/O interface 615. Position sensor 174, weight sensors 172, and temperature sensors 175 are connected to the controller 171 via I/O interface. The layer 801 can be metallic or ceramic or a combination thereof.

It is to be understood that the above description is intended to be illustrative, and not restrictive. For example, the above-discussed embodiments may be used, in combination with each other. Many other embodiments will he apparent to those of skill in the art upon reviewing the above description.

The benefits and advantages which may be provided by the present inventive concept have been described above with regard to specific embodiments. These benefits and advantages, and any elements or limitations that may cause them to occur or to become more pronounced are not to be construed as critical required, or essential features of any or all of the embodiments.

While this specification contains many specific implementation details, these should not be construed as limitations on the scope of any inventive concept of what may be claimed, but rather as descriptions of features that may be specific to particular embodiments of particular inventive concept. Certain features that are described in this specification in the context of separate embodiments can also he implemented in combination in a single embodiment. Conversely, various features that are described in the context of a single embodiment can also he implemented in multiple embodiments separately or in any suitable sub combination.

1. A flat and portable platform for heating a dinner plate, the platform comprising:
at least a temperature sensor configured to sense a temperature of the food received in the dinner plate;
a plurality of weight sensors installed at the bottom of the platform, the plurality of the weight sensors being configured to sense the weight of the food received in the dinner plate;
a power storage element inside the platform;
a heating element configured to heat the dinner plate placed on the platform;
a control circuit configured to receive an electrical signal from the at least one temperature sensor and a plurality of weight sensors to control the operation of the heating element based on the received signal from the temperature sensor and the plurality of weight sensors; and
a wireless transceiver communicating with a remote mobile device or a computer, the wireless transceiver being configured to transmit the sensed temperature and weight signal to the mobile device to display the sensed temperature of the platform.

2. The system according to claim 1, wherein the controller is configured to control the temperature of the platform based on the temperature signal received from the temperature sensor and weight signal received from the weight sensors.

3. The system according to claim 1, wherein the platform includes a display to display the target heating temperature and duration of the heating of the platform.

4. The system according to claim 1, wherein a manual switch is provided on the platform, the manual switch being configured to manually override a set temperature and duration of the heating of the platform.

5. A system, for heating a plurality of dinner plates, the system comprising:
a plurality of flat and portable platforms for heating the plurality of dinner plates, each of the plurality of platforms including,
at least a temperature sensor configured to sense a temperature of the food received in the dinner plate;
a plurality of weight sensors configured to sense the weight of the food received in the dinner plate;
a heating element configured to heat the dinner plate received on the platform;
a power storage element inside the platform to energize the heating element;
a control circuit configured to receive an electric signal from the at least one temperature sensor and a plurality of weight sensors, to control the operation of the heating element based on the received temperature signal from the temperature sensor and the received signal from the plurality of weight sensors;
a wireless transceiver communicating with a remote mobile device or a computer, the wireless transceiver being configured to transmit the sensed temperature and weight signal to the mobile device to display the sensed temperature of the platform;
wherein,
each of the plurality of the platforms are configured to receive a command from the remote mobile device or the computer to control the operation of the heating element each of the plurality of the platforms at a target temperature.

6. The system according to claim 5, wherein a group of the platforms are configured to receive a control command from the mobile device by a single input in the mobile device to control the temperature of the group of the platforms.

7. The system according to claim 5, wherein the single input in the mobile device is a touch input in the touch screen of the mobile device.

8. The system according to claim 5, wherein the mobile device is provided with an application such that in response to sending the sensed temperature or weight information, from the temperature or weight sensors, the mobile device displays a layout of the used platforms by a plurality of users.

9. The system according to claim 8, wherein the layout includes enabled platform positions that are selectable by a user of the mobile device to control the temperature of each of the platforms via a single input or via a plurality of input corresponding to each of the platform.

10. The system according to claim 8, wherein the layout includes a single enabled button that is configured to control the temperature of the plurality of the platforms.

11. The system according to claim 7, wherein the app provides a preselectable temperate ranges to control the temperature of the plurality of the platforms.

12. A charger plate for heating a dinner plate, the charger plate comprising:
at least a temperature sensor configured to sense a temperature of the food received in the dinner plate;
a plurality of weight sensors configured to sense the weight of the food received in the dinner plate;
a heating element configured to heat the dinner plate received on the platform;
a rechargeable battery removeable attached at the bottom of the charger plate to energize the heating element;
a control circuit configured to receive an electric signal from the at least one temperature sensor and a plurality of weight sensors, to control the operation of the heating element based on the received temperature signal from the temperature sensor and the received signal from the plurality of weight sensors;
a wireless transceiver communicating with a remote mobile device or a computer, the wireless transceiver being configured to transmit the sensed temperature and weight signal to the mobile device to display the sensed temperature of the platform;
wherein,
each of the plurality of the platforms are configured to receive a command from the remote mobile device or the computer to control the operation of the heating element each of the plurality of the platform s at a target temperature.

13. The system according to claim 12, wherein the controller is configured to control the temperature of the charge plate based on the temperature signal received from the temperature sensor and weight signal received from the weight sensors.

14. The system according to claim 1, wherein the platform includes a display to display the target heating temperature and duration of the heating of the platform.

15. The system according to claim 1, wherein a manual switch is provided on the platform, the manual switch being configured to manually override a set temperature and duration of the heating of the platform.

16. A charger plate comprising:
a bottom heating element connected to a battery mounted on a slope or elevated portion of the charger plate; and
a switch to tarn on or off a power supply of the battery to the bottom heating element.
